(19) United States
(12) Patent Application Publication
(10) Pub. No.: US 2009/0096901 A1
(43) Pub. Date: Apr. 16, 2009

(54) Image sensor

(76) Inventors: Jeong-Hoon Bae, Seoul (KR); Tae-Seok Oh, Seoul (KR)

Correspondence Address: HARNESS, DICKEY & PIERCE, P.L.C., P.O. BOX 8910, RESTON, VA, 20195, US

(21) Appl. No.: 12/081,041

(22) Filed: Apr. 10, 2008

(30) Foreign Application Priority Data
Apr. 10, 2007 (KR) 10-2007-0035109

(51) Int. Cl. H04N 5/335

(52) U.S. Cl. 348/294; 348/E05.091

(57) ABSTRACT

An image sensor may include a first common column line and/or at least one first pixel. The at least one first pixel may be connected to the first common column line. The at least one first pixel may include a first photoelectron conversion region, a first transfer gate, a first overflow gate, and/or a first overflow drain region. The first transfer gate may be between the first photoelectron conversion region and the first common column line. The first overflow gate may be spaced from the first transfer gate. The first photoelectron conversion region may be between the first overflow gate and the first transfer gate. The first overflow drain region may be on an opposite side of the first photoelectron conversion region with respect to the first transfer gate. The first overflow gate may be between the first overflow drain region and the first photoelectron conversion region.

### PRIORITY STATEMENT

This U.S. non-provisional patent application claims the benefit of priority under 35 U.S.C § 119 to Korean Patent Application No. 10-2007-0035109 filed on Apr. 10, 2007, the entire contents of which are hereby incorporated in their entirety by reference.

### BACKGROUND

1. Field

Example embodiments relate to a semiconductor device, and for example, to an image sensor.

2. Description of Related Art

An image sensor is a device that converts photo images into electrical signals. Image sensors are widely used in many devices, e.g., digital cameras and camera-installed cellular phones.

Generally, image sensors are Charge-Coupled Device (CCD) type image sensors or Complementary Metal Oxide Semiconductor (CMOS) type image sensors. A CCD type image sensor has superior image quality and generates less noise. However, CCD type image sensors have higher unit production cost and higher power consumption than CMOS type image sensors. A CMOS type image sensor may be produced with a more general semiconductor manufacturing technology, which may be more readily integrated with peripheral systems, e.g., systems for amplification and signal processes. Therefore, a CMOS type image sensor costs less to produce, has faster processing, and consumes less power.

A pixel structure of a CMOS type image sensor includes a three-transistor structure or a four-transistor structure. In a three-transistor structure, a single pixel includes one photo diode and three transistors. And, in a four-transistor structure, a single pixel includes one photo diode and four transistors.

With reference to FIG. 1, a conventional four-transistor CMOS image sensor is described. A pixel of a four-transistor CMOS image sensor includes a photo diode PD, a transfer transistor MT, a reset transistor MR, a source follower transistor MD, and a selection transistor MS.

If a gate voltage RG of the reset transistor MR increases to turn on the reset transistor MR, the electric potential of floating diffusion node FD, which is a sensing node, increases to a power source voltage VDD. The electric potential of the floating diffusion node FD is primarily sampled by the source follower transistor MD and the selection transistor MS. The electric potential of the floating diffusion node FD becomes the standard potential.

If light received from the outside enters the photo diode PD, an electron hole pair (EHP) proportionate to the light is generated. If a gate voltage TG of the transfer transistor MT increases, the charge accumulated in the photo diode PD region is transmitted to the floating diffusion node FD. If the electric potential of the floating diffusion node FD decreases in proportion to the amount of the transmitted charge, (e.g., such that a gate voltage DG of the source follower transistor MD decreases), the source electric potential of the source follower transistor MD varies.

If a gate voltage SG of the selection transistor MS increases and turns on the selection transistor MS, the varied source potential of the source follower transistor MD is output to an output port Vₒᵤₜ. The difference between the standard electric potential and the above read electric potential is optically sensed. The above described processes are repeated from the reset operation.

Because the conventional four-transistor image sensor includes four transistors disposed in the pixel, the percentage of the photo diode area compared to the pixel area, e.g. the fill factor, decreases. Accordingly, the optical sensing rate of the image sensor may decrease.

### SUMMARY

An image sensor may include a first common column line and/or at least one first pixel. The at least one first pixel may be connected to the first common column line. The at least one first pixel may include a first photoelectron conversion region, a first transfer gate, a first overflow gate, and/or a first overflow drain region. The first transfer gate may be between the first photoelectron conversion region and the first common column line. The first overflow gate may be spaced from the first transfer gate. The first photoelectron conversion region may be between the first overflow gate and the first transfer gate. The first overflow drain region may be on an opposite side of the first photoelectron conversion region with respect to the first transfer gate. The first overflow gate may be between the first overflow drain region and the first photoelectron conversion region.

According to another example embodiment, the image sensor may include at least one second pixel connected to the first common column line. The at least one first pixel and the at least one second pixel may be connected to the first common column line in parallel. The at least one second pixel may include a second photoelectron conversion region, a second transfer gate, a second overflow gate, and/or a second overflow drain region. The second transfer gate may be between the second photoelectron conversion region and the first common column line. The second overflow gate may be spaced from the second transfer gate. The second photoelectron conversion region may be between the second overflow gate and the second transfer gate. The second overflow drain region may be on an opposite side of the second photoelectron conversion region with respect to the second transfer gate. The second overflow gate may be between the second overflow drain region and the second photoelectron conversion region.

According to still another example embodiment, the image sensor may include a second common column line, and/or the at least one first pixel and at least one second pixel are between the first common column line and the second common column line. The at least one first pixel may be a plurality of the at least one first pixel connected to the first common column line in parallel and/or the at least one second pixel may be a plurality of the at least one second pixel connected to the second common column line in parallel. Each the second pixels may include a second photoelectron conversion region, a second transfer gate, a second overflow gate, and/or a second overflow drain region. The second transfer gate may be between the photoelectron conversion region and the second common column line. The second overflow gate may be spaced from the second transfer gate. The second photoelectron conversion region may be between the second overflow gate and the second transfer gate. The second overflow drain region may be on an opposite side of the second photoelectron conversion region with respect to the second transfer gate. The second overflow gate may be between the second overflow drain region and the second photoelectron conversion region.

### BRIEF DESCRIPTION OF THE DRAWINGS

The above and/or other aspects and advantages will become more apparent and more readily appreciated from the following detailed description of example embodiments taken in conjunction with the accompanying drawings of which:

FIG. 1 illustrates a semiconductor device including a conventional redistribution line structure;

FIG. 2 is a plan view of an image sensor according to an example embodiment;

FIG. 3 is a circuit diagram of the image sensor illustrated in FIG. 2;

FIG. 4 is a plan view of an image sensor according to another example embodiment;

FIG. 5 is a circuit diagram of the image sensor illustrated in FIG. 4;

FIG. 6 is a plan view of the image sensor according to still another example embodiment;

FIG. 7 is a circuit diagram of the image sensor illustrated in FIG. 6; and

FIG. 8 and FIG. 9 are plan views of image sensors according still more example embodiments.

### DETAILED DESCRIPTION OF EXAMPLE EMBODIMENTS

Example embodiments will now be described more fully hereinafter with reference to the accompanying drawings. Embodiments may, however, be in many different forms and should not be construed as being limited to the example embodiments set forth herein. Rather, these example embodiments are provided so that this disclosure will be thorough and complete, and will fully convey the scope to those skilled in the art. In the drawings, the thicknesses of layers and regions may be exaggerated for clarity.

It will be understood that when a component is referred to as being “on,” “connected to” or “coupled to” another component, it can be directly on, connected to or coupled to the other component or intervening components may be present. In contrast, when a component is referred to as being “directly on,” “directly connected to” or “directly coupled to” another component, there are no intervening components present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the example embodiments.

Spatially relative terms, such as “beneath,” “below,” “lower,” “above,” “upper” and the like, may be used herein for ease of description to describe one component or feature's relationship to another component(s) or feature(s) as illustrated in the drawings. It will be understood that the spatially relative terms are intended to encompass different orientations of the device in use or operation in addition to the orientation depicted in the figures.

The terminology used herein is for the purpose of describing particular example embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, and/or components.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Reference will now be made to example embodiments, which are illustrated in the accompanying drawings, wherein like reference numerals refer to the like components throughout.

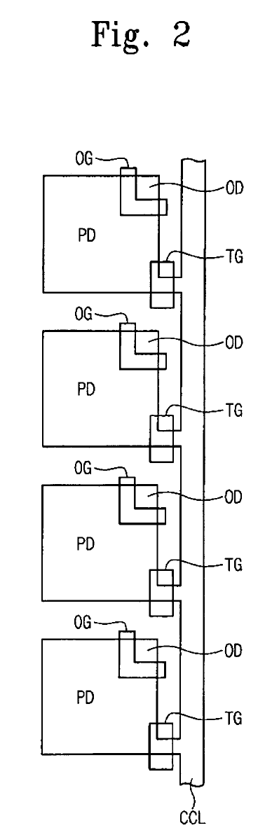

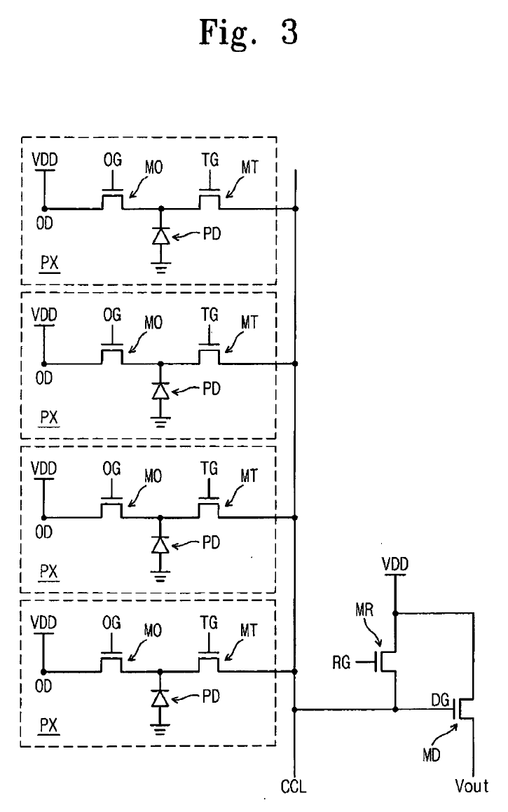

FIG. 2 is a plan view of an image sensor according to an example embodiment. FIG. 3 is a circuit diagram of the image sensor illustrated in FIG. 2.

Referring to FIGS. 2 and 3, an image sensor according to an example embodiment will be described. The image sensor may include pixels PX connected to a common column line CCL in parallel. Each pixel PX may include a photo diode PD, a transfer gate TG, an overflow gate OG, and/or an overflow drain region OD.

The photo diode PD may function as a photoelectron conversion region, and/or include a PN junction having a N-type impurity region and a P-type impurity region. The transfer gate TG may be disposed between the photo diode PD and the common column line CCL. The transfer gate TG may be a gate of a transfer transistor MT, and the N-type impurity region of the photo diode PD and the common column line CCL may be a source and drain of the transfer transistor MT. An overflow gate OG may be spaced apart from the transfer gate TG, and the photo diode PD may be located between the overflow gate OG and the transfer gate TG. An overflow drain region OD may be on an opposite side of the photo diode PD with respect to the transfer gate, and the overflow gate OG may be between the overflow drain region and the photo diode PD. The overflow gate OG may be a gate of an overflow transistor MO, and the overflow drain region OD and the N-type impurity region of the photo diode may be a source and drain of the overflow transistor MO. The overflow drain region OD may be connected to the power source voltage VDD.

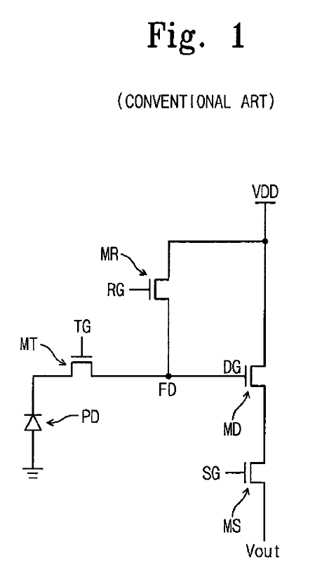

The overflow transistor MO may provide a discharge channel which discharges to the power source voltage VDD the unnecessary photo electrodes exceeding the storage capacity of the photo diode PD. The overflow transistor MO may block the unnecessary photoelectrons from being transferred to the common column line CCL through the transfer transistor MT. For example, in a conventional four-transistor image sensor the transfer transistor functions to transfer photo electrons including optical data to the output port and also functions together with the reset transistor to discharge unnecessary photoelectrons exceeding the storage capacity of the photo diode. However, in an image sensor according to an example embodiment, the transfer transistor MT need only perform the above noted transferring function, and the overflow transistor MO may perform the discharging function. Therefore, a conventional transfer transistor of a conventional image sensor requires a row selection transistor which selects an Effective Integration Time (EIT) interval or an Non-effective Integration Time (NIT) interval, because the conventional transfer transistor performs different functions according to whether an Effective Integration Time (EIT) interval is performing the transfer function or a Non-effective Integration Time (NIT) interval is performing the discharge function. However, in an image sensor according to the example embodiments, the transfer transistor MT need only perform the transfer function, and therefore, a division between an EIT interval or an NIT interval is not required, and/or a row selection transistor that selects the EIT or the NIT interval is not required. According to example embodiments, the transfer transistor MT may receive the transfer gate signal in substitute for the selection signal a conventional selection transistor (e.g., MS of FIG. 1) receives. If the transfer transistor MT receives the transfer gate signal successively in row line units, the transfer transistor MT may function as the selection transistor, and therefore, the selection transistor may be removed.

A source follower transistor MD and/or a reset transistor MR may be coupled to the common column line CCL. A source follower gate DG, e.g., a gate of the source follower transistor MD, may be electrically connected the common column line CCL and receive as input the electrical potential of the common column line CCL. A source potential of the source follower transistor MD may be changed in response to the electrical potential of the common column line CCL, and the changed source potential may be output to the output port Vₒᵤₜ. A source of the source follower transistor MD may be electrically connected to the output port Vₒᵤₜ, and a drain of the source follower transistor may be electrically connected to the power source voltage VDD. A source of the reset transistor MR may be electrically connected to the common column line CCL, and a drain of the reset transistor MR may be electrically connected to the power source voltage VDD. The reset transistor MR may reset the electrical potential of the common column line CCL, e.g., in response to an electrical potential of at a gate RG of the reset transistor MR.

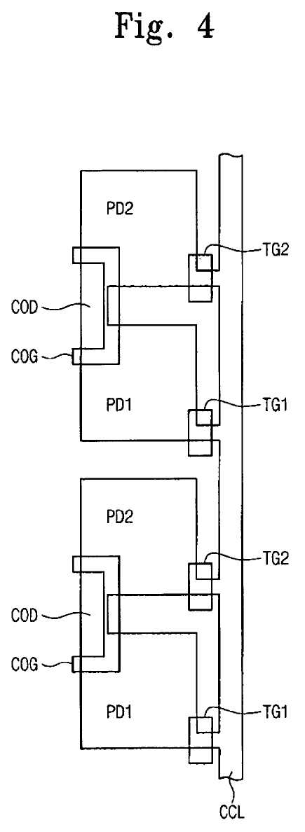

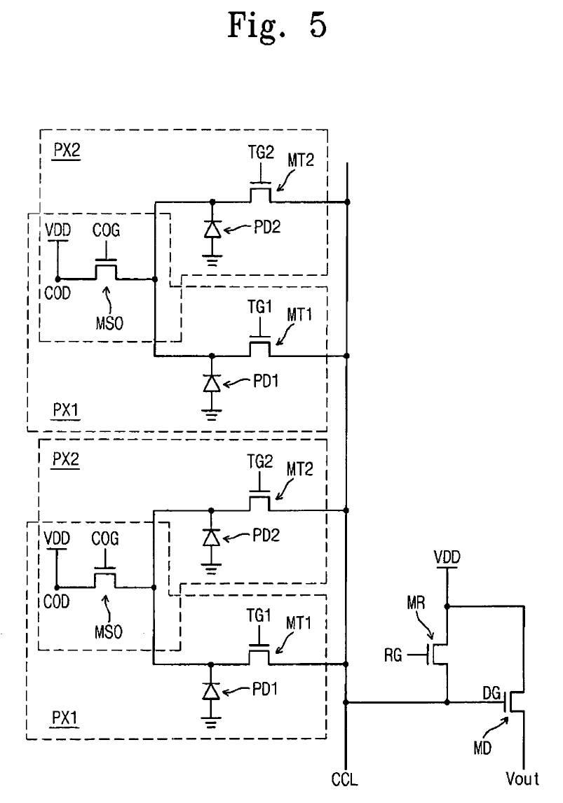

FIG. 4 is a plan view of an image sensor according to another example embodiment. FIG. 5 is a circuit diagram of the image sensor illustrated in FIG. 4.

Referring to FIGS. 4 and 5, an image sensor according to another example embodiment will be described. The image sensor may include groups of a first and a second pixel PX1 and PX2 connected to a common column line CCL in parallel.

The first pixel PX1 may include a first photo diode PD1, a first transfer gate TG1, a common overflow gate COG, and/or a common overflow drain region COD. The second pixel PX2 may include a second photo diode PD2, a second transfer gate TG2, the common overflow gate COG, and/or the common overflow drain region COD. The first pixel PX1 and the second pixel PX2 of another example embodiment may share the same overflow gate and/or the same overflow drain region. The common overflow gate COG and the common overflow drain region COD may serve as the overflow gate and overflow drain region of each of the first pixel PX1 and the second pixel PX2. However, in another example embodiment, the first pixel PX1 and the second pixel PX2 may share only one of either the overflow gate or the overflow drain region.

The common overflow drain region COD may be connected to a power source voltage VDD. A source of a common overflow transistor MSO, which includes the common overflow gate COG, may be connected to the common overflow drain region COD, and/or a drain of the common overflow transistor MSO may be connected to the first and second photo diodes PD1 and PD2. A source of a first transfer transistor MT1, which includes the first transfer gate TG1, may be connected to the first photo diode PD1, and/or a drain of the first transfer transistor MT1 may be connected to the common column line CCL. A source of a second transfer transistor MT2, which includes the second transfer gate TG2, may be connected to the second photo diode PD2, and/or a drain of the second transfer transistor MT2 may be connected to the common column line CCL.

As in example embodiments described above with reference to FIGS. 2 and 3, a source follower transistor MD and a reset transistor MR may be coupled to a common column line CCL as shown in FIG. 5.

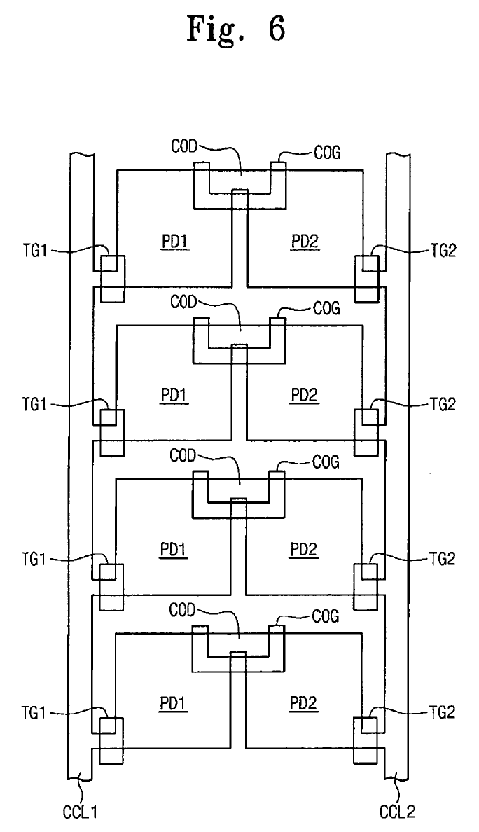

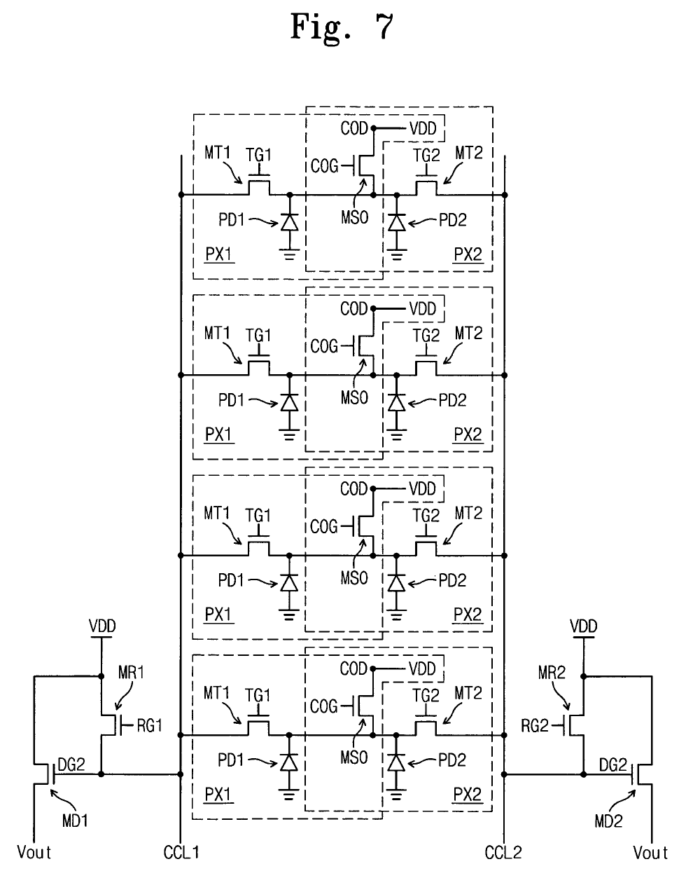

FIG. 6 is a plan view of the image sensor according to still another example embodiment. FIG. 7 is a circuit diagram of the image sensor illustrated in FIG. 6

Referring to FIGS. 6 and 7, an image sensor according to still another example embodiment will be described. The image sensor may include a first common column line CCL1 and/or a second common column line CCL2 disposed parallel to each other. Groups of the first pixel PX1 and the second pixel PX2 may be interposed between the first common column line CCL1 and the second common column line CCL2. The first pixels PX1 of the groups may be connected to the first common column line CCL1 in parallel, and the second pixels PX2 of the groups may be connected to the common column line CCL2 in parallel.

The first pixel PX1 may include a first photo diode PD1, a first transfer gate TG1, a common overflow gate COG, and/or a common overflow drain region COD. The second pixel PX2 may include a second photo diode PD2, a second transfer gate TG2, the common overflow gate COG, and/or the common overflow drain region COD. The first pixel PX1 and the second pixel PX2 of an example embodiment may share the same overflow gate and/or overflow drain region. The common overflow gate COG and the common overflow drain region COD may serve as the overflow gate and overflow drain region of each of the first pixel PX1 and the second pixel PX2. However, in another example embodiment, the first pixel PX1 and the second pixel PX2 may share only one of either the overflow gate or the overflow drain region.

A source of a first transfer transistor MT1, which includes the first transfer gate TG1, may be connected to the first common column line, and/or a drain of the first transfer transistor MT1 may be connected to the first photo diode PD1. The first photo diode PD1 may be connected to the second photo diode PD2, and/or a source of a common overflow transistor MSO may be connected to the first and second photo diodes PD1 and PD2. A drain of the common overflow transistor may be connected to the common overflow drain region, which is connected to the power source voltage VDD. A source of a second transfer transistor MT2, which includes the second transfer gate TG2, may be connected to the second photo diode PD2, and a drain of the second transfer transistor may be connected to the second common column line CCL2.

Similar to example embodiments described above with reference to FIGS. 2-5, a first source follower transistor MD1 and a first reset transistor MR1 may be coupled to the common column line CCL1, and/or a second source follower transistor MD2 and a second reset transistor MR2 may be coupled to the common column line CCL2.

In the above-described example embodiments, two pixels may share the same overflow gate and/or the same overflow drain region. However, example embodiments are not limited thereto, and three or more pixels may share the same overflow gate and/or the same overflow drain region.

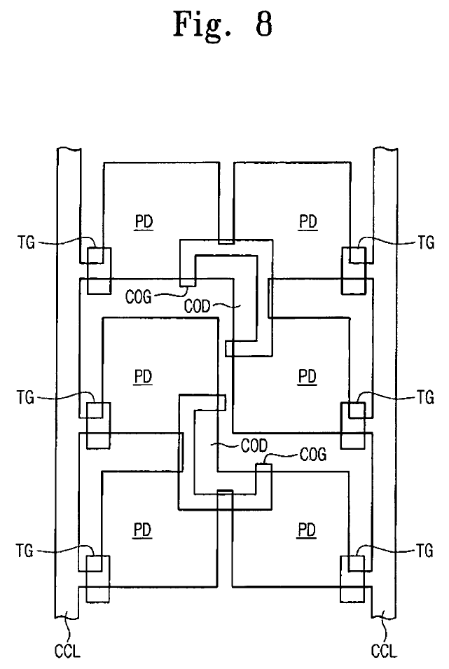

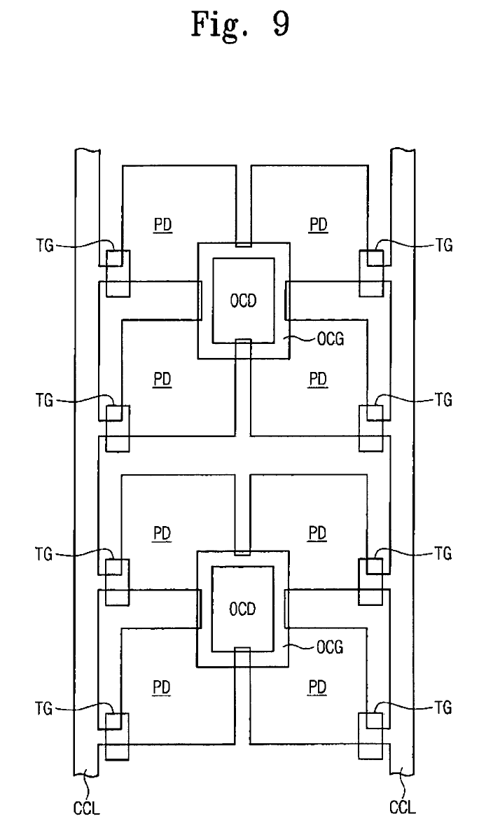

FIG. 8 and FIG. 9 are plan views of image sensors according still more example embodiments.

Referring to FIG. 8, three pixels, e.g., three photo diodes PD of the three pixels, may share one overflow gate COG and/or one overflow drain region COD. Referring to FIG. 9, four pixels adjacent to each other, e.g., three photo diodes PD of the four adjacent pixels, may same one overflow gate COG and/or one overflow drain region COD.

As described above, pixels of an image sensor according to example embodiments may be configured in a transistor structure. The fill factor of the pixels may increase because the pixels may include two less transistors than a conventional four-transistor structure. Accordingly, an optical sensing rate of the image sensor may be increased.

Example embodiments may employ a shared structure which shares a reset transistor, a source follower transistor, and/or a selection transistor in order to produce an image sensor having a greater fill factor while having a smaller pixel size. A shared structure according to example embodiments may increase an area of a photo diode region by being configured to share transistors which serve to amplify and transfer signals to an internal circuit. However, in a conventional shared structure, structure and interconnection of the conventional shared structure are more complicated, and therefore, sharing transistors is more difficult. Because of the complicated interconnection structure of a conventional shared structure, a manufacturing process becomes more complicated, which may result in lower yield or productivity. In the image sensor according to example embodiments, an overflow transistor may be included in a pixel such that a row selection transistor and/or a selection transistor may be removed to simplify an interconnection structure. Accordingly, a manufacturing process may be simplified.

Although example embodiments have been shown and described in this specification and figures, it would be appreciated by those skilled in the art that changes may be made to the illustrated and/or described example embodiments without departing from their principles and spirit.

What is claimed is:

1. An image sensor comprising:
a first common column line; and
at least one first pixel connected to the first common column line, wherein the at least one first pixel includes:
a first photoelectron conversion region;
a first transfer gate between the first photoelectron conversion region and the first common column line;
a first overflow gate spaced from the first transfer gate, wherein the first photoelectron conversion region is between the first overflow gate and the first transfer gate; and
a first overflow drain region on an opposite side of the first photoelectron conversion region with respect to the first transfer gate, wherein the first overflow gate is between the first overflow drain region and the first photoelectron conversion region.

2. The image sensor as claimed in claim 1, wherein the at least one first pixel is a plurality of the at least one first pixel connected to the first common column line in parallel.

3. The image sensor as claimed in claim 2, wherein the first overflow drain region of each of the pixels is connected to a power source voltage.

4. The image sensor as claimed in claim 2, wherein adjacent two pixels share a first overflow drain region.

5. The image sensor as claimed in claim 2, wherein adjacent two pixels share a first overflow gate.

6. The image sensor as claimed in claim 2, further comprising:
a source follower transistor including a gate configured to receive an electric potential of the first common column line; and
a reset transistor connected to the first common column line and configured to reset the electric potential of the first common column line.

7. The image sensor as claimed in claim 6, wherein
the gate of the source follower transistor and a source of the reset transistor are coupled to each other, and
a drain of the source follower transistor and a drain of the reset transistor are connected to a power source voltage.

8. The image sensor of claim 1, further comprising:
at least one second pixel connected to the first common column line, the at least one first pixel and the at least one second pixel connected to the first common column line in parallel, wherein the at least one second pixel includes:
a second photoelectron conversion region;
a second transfer gate between the second photoelectron conversion region and the first common column line;
a second overflow gate spaced from the second transfer gate, wherein the second photoelectron conversion region is between the second overflow gate and the second transfer gate; and
a second overflow drain region on an opposite side of the second photoelectron conversion region with respect to the second transfer gate, wherein
the second overflow gate is between the second overflow drain region and the second photoelectron conversion region.

9. The image sensor as claimed in claim 8, wherein
the at least one first pixel is a plurality of the at least one first pixel connected to the first common column line in parallel, and
the at least one second pixel is a plurality of the at least one second pixel connected to the first common column line in parallel.

10. The image sensor as claimed in claim 8, wherein the first overflow drain region and the second overflow drain region are electrically connected to each other.

11. The image sensor as claimed in claim 8, wherein the first overflow gate and the second overflow gate are electrically connected to each other.

12. The image sensor as claimed in claim 8, wherein the first and the second overflow drain regions are a same overflow drain region.

13. The image sensor as claimed in claim 8, wherein the first and the second overflow gates are a same overflow gate.

14. The image sensor as claimed in claim 8, wherein the first and the second overflow drain regions are connected to a power source voltage.

15. The image sensor as claimed in claim 8, further comprising:
a source follower transistor including a gate configured to receive an electrical potential of the first common column line; and
a reset transistor connected to the first common column line and configured to reset the electrical potential of the first common column line.

16. The image sensor as claimed in claim 15, wherein
the gate of the source follower transistor and a source of the reset transistor are coupled to each other, and
a drain of the source follower transistor and a drain of the reset transistor are connected to a power source voltage.

17. The image sensor as claimed in claim 1, further comprising:
a second common column line, wherein
the at least one first pixel and at least one second pixel are between the first common column line and the second common column line, the at least one first pixel is a plurality of the at least one first pixel connected to the first common column line in parallel and the at least one second pixel is a plurality of the at least one second pixel connected to the second common column line in parallel,
wherein each the second pixels include:
a second photoelectron conversion region;
a second transfer gate between the second photoelectron conversion region and the second common column line;
a second overflow gate spaced from the second transfer gate, wherein the second photoelectron conversion region is between the second overflow gate and the second transfer gate; and
a second overflow drain region on an opposite side of the second photoelectron conversion region with respect to the second transfer gate, wherein the second overflow gate is between the second overflow drain region and the second photoelectron conversion region.

18. The image sensor as claimed in claim 17, wherein the overflow drain region is connected to a power source voltage.

19. The image sensor as claimed in claim 17, wherein the first overflow drain region of at least one of the first pixels is a same overflow drain region as the second overflow drain region of at least one of the second pixels.

20. The image sensor as claimed in claim 17, wherein the first overflow gate of at least one of the first pixels is a same overflow gate as the second overflow gate of at least one of the second pixels.
